(19) United States
(12) Patent Application Publication
(10) Pub. No.: US 2002/0122931 A1
(43) Pub. Date: Sep. 5, 2002

(54) PAPERS AND CARDBOARD PRODUCTS SUITABLE FOR LASER MARKING, METHOD FOR PRODUCING SAME AND THEIR USE FOR PACKAGING MATERIALS, BANK NOTES AND SECURITIES, SECURITY PAPER AND GRAPHIC PRODUCTS

(76) Inventors: ALEXANDRA BROWNFIELD, MIDLAND PARK, NY (US); FIONA HALL, GAUTENG PROVINCE (ZA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/367,040

(22) PCT Filed: Jan. 27, 1998
(86) PCT No.: PCT/EP98/00431

(30) Foreign Application Priority Data
Feb. 6, 1997 (DE) 197 04 478.6

(51) Int. Cl. B32B 23/08; B32B 5/16

(52) U.S. Cl. 428/324; 428/512; 428/513; 428/537.5

(57) ABSTRACT

The present invention relates to papers and cardboard products suitable for laser marking which are characterized in that as absorbing agents they contain inorganic, platelet-shaped substrates with a particle size of between 1 and 60 &mgr;m. The invention further relates to a method for producing papers and cardboard products suitable for laser marking, as well as their use for packaging materials, bank notes and securities. security paper and graphic products.

The present invention relates to laser-markable paper and board products of which a feature is that they comprise, as absorber material, inorganic platelet-form substrates having a particle size of from 1 to 60 μm.

The placing of distinguishing marks on products is becoming increasingly important in almost all sectors of industry. For example, it is frequently necessary to apply production dates, expiry dates, bar codes, company logos, serial numbers, etc. At present, these markings are predominantly executed using conventional techniques, such as printing, embossing, stamping and labelling. However, the importance of non-contact, high-speed and flexible marking using lasers is increasing. This technique makes it possible to apply graphic inscriptions, for example bar codes, at high speed even on a non-planar surface.

In printed products for the packaging sector (folding cartons, labels, etc.), there is ever more frequently a requirement that direct laser marking, coding and inscription of the paper and board products used should be possible, without the printing-on of additional fields.

It was therefore an object of the present invention to find laser-markable paper products which, when treated with laser light, make it possible to achieve a marking which has good legibility and crisp edges. Paper is difficult or impossible to mark with a laser, because its layer thickness is low. To make the paper capable of laser inscription, it was necessary to incorporate into it appropriate absorbers. The absorber material here should have a very pale neutral intrinsic colour, and/or have the properties of the paper product to be marked, and at the same time be required only in small amounts.

Surprisingly, it has now been found that if inorganic platelet-form substrates having a particle size of from 1 to 60 μm are incorporated as absorber material directly into the body or coating of the paper, the markings obtained on paper and board products have high contrast, crisp edges and good legibility.

The invention therefore provides laser-markable paper and board products, characterized in that they comprise, as absorber material, inorganic platelet-form substrates having a particle size of from 1 to 60 μm.

Adding the platelet-form substrates in concentrations of from 0.1 to 10% by weight based on the body of the paper, preferably from 1 to 5% by weight and in particular from 1 to 2% by weight, achieves high contrast in the laser marking. However, the concentration of the pigments in the body of the paper depends on the type of the body of the paper and on the thickness of the paper and the energy density of the laser used. The relatively low proportion of absorber material neither alters the paper product significantly nor has any effect on its processability.

Inorganic platelet-form substrates suitable for the marking preferably have particle sizes in the range from 1 to 40 μm, in particular from 1 to 20 μm. Particularly suitable absorber materials are TiO₂ flakes, BiOCl, pur SiO₂ flakes or SiO₂ flakes coated with one or more metal oxides, phyllosilicates, such as calcined and uncalcined mica, glass, talc, kaolin and sericite, and the mica used is particularly preferably muscovite, biotite, phlogopite, vermiculite or else synthetic mica. The phyllosilicate used is preferably mica. The phyllosilicates have particle sizes of from 5 to 20 μm.

Any known pearl lustre pigment having a particle size of <60 μm, preferably <40 μm, in particular <20 μm, may be used as absorber, as described, for example, in the German Patents and Patent Applications 14 67 468, 19 59 998, 20 09 566, 22 14 545, 22 15 191, 22 44 298, 23 12 331, 25 22 572, 31 37 808, 31 37 809, 31 51 343, 31 51 354, 31 51 355, 32 11 602, 32 35 017 and 38 42 330. However, particular preference is given to pearl lustre pigments based on mica flakes coated with metal oxides, in particular titanium dioxide and/or iron oxide. Non-glossy mica pigments coated with metal oxides are disclosed in DE-A-44 21 223 and DE-A-19 546 058. A combination made from a mixture of different inorganic platelet-form substrates in any desired mixing ratios may also be used as absorber material.

However, preference is given to the use of phyllosilicates, in particular mica, pearl lustre pigments, in particular mica pigments coated with TiO₂, Fe₂O₃ and/or Fe₃O₄ and electrically conductive platelet-form pigments, as disclosed, for example, in DE-A-38 42 330, alone or in a mixture. In a further preferred embodiment, the combination of pearl lustre pigments with spherical TiO₂ particles gives very good marking results.

During the marking, the absorption achieved with the platelet-form substrate must not be so strong that that area of the paper burns through and only a black speck and/or a hole is left on the paper. The absorption of the laser radiation and the interaction with the absorber depends on many factors, inter alia on the paper used, on the absorber and on the laser wavelength used. High-energy radiation is preferably used for the marking, generally in the wavelength range from 150 to 1500 nm, preferably from 150 to 1100 nm.

Examples which may be mentioned here are CO₂ lasers (1060 nm), Nd:YAG lasers (1067 or 532 nm) and pulsed UV lasers (excimer lasers).

Nd:YAG lasers (1064 or 532 nm) and CO₂ lasers (1060 nm) are particularly preferably used. The energy densities of the lasers used are generally in the range from 0.3 mJ/cm² to 50 J/cm², preferably from 0.5 mJ/cm² to 20 J/cm² and particularly preferably from 0.3 mJ/cm² to 10 J/cm².

When pulsed lasers are used, the pulse frequency is generally in the range from 0.1 to 20,000 Hz, preferably from 1500 to 15,000 Hz and in particular from 2000 to 10,000 Hz.

Depending on the energy density of the laser used and on the pulse length and the type of paper product irradiated, the number of pulses required to achieve good inscriptions is generally from 1 to 20,000, preferably from 1 to 5000 and in particular from 1 to 3000.

Very good marking results are achieved with the YAG laser if the pulse frequency is from 1500 to 2000 Hz or from 15,000 to 20,000 Hz, the current is from 12 to 14A or from 20 to 22A and the marking speed is from 20 to 30 mm/s or from 150 to 200 mm/s.

The novel process makes it possible to obtain with the aid of a laser, on any paper or board product, an inscription which has crisp edges and high contrast. The inscription with the laser is brought about by placing the specimen in the path of a laser beam, preferably of a CO₂ or Nd:YAG laser. Inscription with an excimer laser is also possible. However, the desired results may also be achieved with other conventional types of laser which have a wavelength in the high absorption range of the absorber used. The shade and depth of colour obtained are determined by the laser parameters, such as the time and power of irradiation. The power of the laser used depends on the individual application, and can easily be determined in a given case by the person skilled in the art.

Paper and board products, in particular for the packaging sector, are generally composed of from 70 to 100% of natural and synthetic fibres, which, with from 20 to 30% of fillers and sizes, form the middle layer of the paper. From one to three uniform applications onto the raw paper of a coating composition, consisting of pigments for white coloration, binders and additives achieves a sealed, smooth surface for the printing and further processing which are to follow. The coated papers are calendered matt or gloss and are produced coated on one or both sides.

The paddle stirrers and shapes of vessels used in the paper industry are suitable for incorporating the absorber materials into the body of the paper. The absorber material can be stirred in during the production of the paper stock at any stage in the process before the paper machine is fed.

Paper generally consists of mechanical and/or chemical pulp and, if desired, synthetic fibres and the materials termed papermaking auxiliaries, for example fillers, binders for sizing, retention aids, optical brighteners and dyes. The absorber can be incorporated into the body of the paper in various ways. The absorber material can, for example, be mixed with the chemical and/or mechanical pulp in dry form. Alternatively, the absorber can be admixed with the fibrous stock made from chemical and/or mechanical pulp. A homogeneous distribution of the absorber material is likewise achieved if the absorber material is added to the individual components of the papermaking auxiliary. It is particularly preferable here to add the absorber material to the binder necessary for sizing the paper. However, it is also possible not to add the absorber material until the fibrous stock is mixed with the papermaking auxiliaries. The finished paper stock then goes to the paper machine.

The raw paper with the absorber is generally coated one or more times on one or both sides. It is likewise possible to stir the absorber material into the coating material. However, if this is done, the total proportion of the absorber material in the raw paper and in the coating should not exceed the upper limit of 10% by weight, based on the body of the paper, since otherwise the marking may not have crisp edges. However, the absorber material may also be incorporated into the paper or board product by coating the raw paper without absorber material, using a coating composition with absorber material. In this case, the absorber is present only in the coating material and not in the actual body of the paper.

The fibrous materials used besides mechanical and chemical pulp are in particular the modified mechanical pulps, such as thermomechanical pulp and chemo-thermo-mechanical pulp and/or mixtures of these. It is furthermore also possible to use reclaimed chemical pulp from used paper. The marking result is favourably affected if the fibres mentioned contain a proportion of man-made fibres, in particular cellulose derivatives, such as cellulose esters, cellulose ethers, acetate, viscose, carbon fibres, high-strength, heat-resistant aramid fibres, polyterephthalates, polymers and also copolymers. Additives of this type have a favourable effect on the crispness of the edges and the depth of colour of the marking.

To improve smoothness, printability and opacity of the paper, fillers, such as CaCO₃, BaSO₄, Al(OH)₃, CaSO₄, ZnS, SiO₂, chalk, TiO₂ and kaolin are added to the fibrous starting materials. These fillers are also used as coating pigments for improving surface quality in coating compositions or cast coatings.

Other important constituents of the papermaking auxiliaries are the binders, such as starch, casein, proteins, plastics dispersions, resin sizes, etc., for strengthening the fibre structure, binding fillers and pigments, increasing water-resistance and improving inscribability and printability. The selection of a suitable organic binder can favourably affect the marking result. Particularly good marking results are obtained if the binder is mixed with the absorber material and this is admixed with the mechanical and/or chemical pulp, in solid or liquid form. Binders which are particularly suitable are solvent-free sizes which are also used in paper coating, coating and impregnation. Preferred binders are cationic resin sizes, colophonium, modified colophonium esters, synthetic alkyldiketenes and alkyl diacrylates. Other binders which should be mentioned here are vinyl-acetate-based and acrylate-resin-based plastics dispersions and also chlorinated polypropylene, PVC copolymers, polyvinylene chloride, polyvinyl acetate, polyvinyl propionate, polyvinyl alcohol and polyvinyl ethers and thermoplastics, for example polyurethanes, polyamines, polyolefins, such as LLPE, LLDPE, HDPE, polyethylene oxide, styrene polymers, such as PS and ABS, styrene copolymers of styrene and butadiene, vinyl chloride polymers and polyester resins, phenol-formaldehyde resins, colophonium-modified phenol-formaldehyde condensates, alkyd and terpene-phenol resins, urea-formaldehyde, poly(meth)acrylate plastics, polyamides (PA) and thermoplastic polyurethanes, polyesters, polyarylene ethers, polyarylene sulfides and polyarylene sulfones.

In the case of coated paper, the raw paper is preferably coated using binders from the range of copolymers of styrene and butadiene. The abovementioned binders may likewise be used in the finishing of the paper.

The combination of the absorber material with the binders mentioned gives a synergistic effect and improves the marking result by making the markings darker and giving them crisper edges.

The retention aids used during papermaking to retain fines and fillers are in particular aluminium sulfate and synthetic cationic compounds, such as ethyleneimine polymers.

It is moreover advisable to use dispersants, since the inorganic, platelet-form substrates should be distributed very homogeneously in the body of the paper so that a uniform and clear marking can be achieved. Examples of suitable dispersants are Byk 410, Byk 346 (Byk-Chemie), Laponite RD/RDS (Laporte), Calgon neu (BK Ladenburg) and Polysalz SK (BASF).

Depending on the grade of paper in the body of the paper, optical brighteners are frequently added to increase whiteness.

Besides dyes and pigments for colouring the body of the paper or, in coating compositions, for coloration of the surface, in a preferred embodiment the paper may also contain other light-sensitive pigments. Particular examples are the oxides, hydroxides, sulfides, sulfates and phosphates of copper, bismuth, tin, zinc, silver, antimony, manganese, iron, nickel and chromium. The use of copper phosphate, in particular a copper(II) hydroxide phosphate, should be mentioned in particular here. A particularly preferred product here is that which has the stoichiometric chemical formula 4CuO*P₂O₅*H₂O or Cu₃(PO₄)₂*Cu(OH)₂ and is obtained by heating blue Cu(II) orthophosphate (Cu₃(PO₄)₂*3H₂O) to from 100 to 200° C. Other suitable copper phosphates are 6CuO*P₂O₅*3H₂O, Cu₃(PO₄)₂*3Cu(OH)₂, 5CuO*P₂O₅*3H₂O, Cu₃ (PO₄)₂*2Cu (OH)₂*H₂O, 4CuO*P₂O₅, 4CuO*P₂O₅*3H₂O, 4CuO*P₂O₅*1.5H₂O and 4CuO*P₂O₅*1.2H₂O.

The proportion by weight of light-sensitive pigments in the body of the paper, combined with the absorber materials, should not in total exceed 10% by weight, based on the body of the paper.

The mixing ratio of the light-sensitive pigments with the platelet-form inorganic substrates is not per se subject to any particular limitation.

The light-sensitive pigments are preferably added together with the absorber, but in principle it is also possible to add them separately. It is also possible to add a mixture of different light-sensitive pigments to the paper stock.

Besides the papermaking auxiliaries usually used, it is also possible to add other additives not mentioned here to the paper stock.

The novel pigmented paper product may be used in any sector where paper has hitherto been inscribed using ink-jet processes or laser-marking by removal of printing inks. Inscriptions and distinguishing marks can be made with the aid of laser light on, for example, labels, any type of paper packaging for household products and consumer goods, wrapping paper, cigarette packaging and cosmetics, even at positions which are difficult to access. Because of its low heavy metal content, the novel paper product can furthermore be used in packaging in the food and toy sectors. The markings on the packaging are notable for their wipe- and scratch-resistance and for their ability to be applied hygienically in the marking process. Another important application sector for laser inscription is given by graphic products which have a permanent and counterfeit-proof marking and which also meet the highest aesthetic demands relating to high-quality packaging print, since there is no need for white or black areas to be printed into the design for subsequent laser-marking. Another application sector is in counterfeit-proof securities and security prints, such as banknotes, cheques, cheque cards, credit cards, identity cards, etc.

The marked paper products and board products can moreover be subsequently printed and further processed, for example surface-coated, laminated or sealed, without adverse effect on their markability.

The examples below are intended to explain the invention but not to limit the same.

### EXAMPLES

### Production of Paper with Label Paper Formulation

### Example 1

Base paper having a weight per unit area of about 70 g/m² and consisting of:

Fibre: 100% of chemical pulp beaten to about 30° SR 7%, based on fibre, of calcium carbonate as filler in the paper

0.5% of colophonium (size)

0.1% of cationic polyethyleneimine (Polymin SK, BASF) as retention aid

1.5%, based on fibre, of LS 820 (TiO₂ mica pigment having an SiO₂ layer and a conductive layer of (Sn, Sb)O₂ of particle size from 1 to 15 μm from Merck KGaA, Darmstadt, Germany)

The label paper produced in this way is inscribed using a laser. Marking with a YAG laser (1500 Hz, 19A, 20 mm/s) gives a dark marking with crisp edges and high contrast.

### Example 2

Base paper having a weight per unit area of about 70 g/m² and consisting of:

Fibre: 100% of chemical pulp beaten to about 30° SR

7%, based on fibre, of TiO₂ as filler in the paper 0.5% of synthetic alkyldiketene (Aquapel 2B, Herkules Siegburg)

0.1% of cationic polyethyleneimine

1.5%, based on fibre, of LS 810 (TiO₂ mica pigment having a particle size from 8 to 28 μm from Merck KGaA, Darmstadt, Germany)

The label paper is inscribed using a CO₂ laser (energy density—2 J/cm²) or a YAG laser (15,000 Hz, 21A, 150 mm/s). In both cases, the marking obtained is dark and has crisp edges.

### Example 3

Base paper having a weight per unit area of about 70 g/m² and consisting of:

Fibre: 100% of chemical pulp beaten to about 30° SR

7%, based on fibre, of barium sulfate as filler in the paper

0.5% of colophonium

0.1% of cationic polyethyleneimine

1.5%, based on fibre, of LS 825 (mica pigment having a conductive layer of (Sn, Sb)O₂ of particle size from 1 to 15 μm from Merck KGaA, Darmstadt, Germany)

The label paper is inscribed using a YAG laser (1500 Hz, 19A, 20 mm/s). The marking is dark and has crisp edges and high contrast.

### Example 4

### Use of Absorber Material in the Paper Coating

Base paper having a weight per unit area of about 70 g/m² and consisting of:

Fibre: 100% of chemical pulp beaten to about 30° SR

7%, based on fibre, of calcium carbonate

0.5% of colophonium

0.1% of cationic polyethyleneimine

Coated layer

Coating application: 10 g/m² and 20 g/m²

Filler: calcium carbonate+kaolin

Binder: 10%, based on filler, of styrene copolymers

Absorber: 1.5%, based on filler, of LS 810

Using a CO₂ laser (energy density—2 J/cm²) or a YAG laser (20,000 Hz, 21A, 120 mm/s), the coated paper in both cases shows a dark marking and high contrast.

### Example 5

### Use of Absorber Material in the Body of the Paper and in the Paper Coating

Base paper having a weight per unit area of about 70 g/m² and consisting of:

Fibre: 100% of chemical pulp beaten to about 30° SR

7%, based on fibre, of calcium carbonate

0.5% of colophonium

0.1% of cationic polyethyleneimine

1.5%, based on fibre, of LS 800

Coated layer

Coating application: 10 g/m² and 20 g/m²

Filler: calcium carbonate+kaolin

Binder: 10%, based on filler, of styrene copolymers

Absorber: 1.5%, based on filler, of LS 810

Using a CO₂ laser (energy density—2 J/cm²), the coated paper shows a dark marking and high contrast.

### Example 6

Base paper having a weight per unit area of about 70 g/m

Fibre: 100% of CTMP beaten to about 30° SR

8%, based on fibre, of calcium carbonate

0.5% of colophonium

0.1% of cationic polyethyleneimine

1.5%, based on fibre, of LS 820

The label paper is inscribed using a YAG laser (1500 Hz, 19A, 20 mm/s) . The marking is dark and has crisp edges and high contrast.

### Example 7

Base paper having a weight per unit area of about 70 g/m²

Fibre: 100% of CTMP beaten to about 30° SR

8%, based on fibre, of calcium carbonate

0.5% of colophonium

0.1% of cationic polyethyleneimine

1.5%, based on fibre, of LS 800 (mica pigment of particle size from 1 to 15 μm from Merck KGaA, Darmstadt, Germany)

Using a CO₂ laser (energy density—2 J/cm²), the coated paper shows a dark marking and high contrast.

### Example 8

### Use of Absorber Material in the Board and in the Paper Coating

Board having a weight per unit area of about 200 g/m² and consisting of:

65% of CTMP+35% of wood fibre (60% birch and 40% pine)

1.0% of colophonium

0.5% of cationic polyethyleneimine

2.0%, based on fibre, of LS 820

Coated layer

Coating application: 30 g/m² and 30 g/m²

Filler: TiO2+kaolin

Binder: styrene-butadiene dispersion

Absorber: 1.5%, based on filler, of LS 820

Using a CO₂ laser (energy density—2 J/cm²), the board shows a dark marking and high contrast.

1. Laser-markable paper and board products, characterized in that the paper comprises, as absorber material, an inorganic platelet-form substrate having a particle size of from 1 to 60 μm.

2. Laser-markable paper and board products according to claim 1, characterized in that the inorganic platelet-form substrate is mica.

3. Laser-markable paper and board products according to claim 1, characterized in that the platelet-form inorganic substrate is a pearl lustre pigment.

4. Laser-markable paper and board products according to claim 1, characterized in that the inorganic platelet-form substrate is an electrically conductive pigment.

5. Laser-markable paper and board products according to claim 1, characterized in that the absorber material is a mixture of different inorganic platelet-form substrates.

6. Laser-markable paper and board products according to any one of claims 1 to 5, characterized in that the proportion of the absorber material is from 0.1 to 10% by weight, based on the body of the paper.

7. Laser-markable paper and board products according to any one of claims 1 to 6, characterized in that they also contain colour pigments.

8. Laser-markable paper and board products according to any one of claims 1 to 7, characterized in that they also contain light-sensitive pigments.

9. Process for producing laser-markable paper and board products according to claim 1, characterized in that, during papermaking, the absorber material is stirred into the paper stock and/or into the coating material.

10. Use of laser-markable paper and board products according to claim 1 in the sectors of packaging, securities, security papers and graphic products.
